(19) United States
(12) Patent Application Publication
(10) Pub. No.: US 2016/0380364 A1
(43) Pub. Date: Dec. 29, 2016

(54) MULTI-FIN ANTENNA ASSEMBLY

(71) Applicants: Ming-Tsung HUNG, Taichung City (TW); Hung-Peng HSU, Hsinchu County (TW); Han-Ching CHANG, Hsinchu County (TW); Chia-Hsin CHAO, Taichung City (TW)

(72) Inventors: Ming-Tsung HUNG, Taichung City (TW); Hung-Peng HSU, Hsinchu County (TW); Han-Ching CHANG, Hsinchu County (TW); Chia-Hsin CHAO, Taichung City (TW)

(73) Assignee: WHA YU INDUSTRIAL CO., LTD., Hsinchu City (TW)

(21) Appl. No.: 14/753,772

(22) Filed: Jun. 29, 2015

(51) Int. Cl. H01Q 21/28; H01Q 1/38

(52) U.S. Cl. CPC H01Q 21/28; H01Q 1/38

(57) ABSTRACT

A multi-fin antenna assembly includes a seat, at least two fin antennas disposed on the seat and corresponding to each other, and a housing mounted onto the seat for covering the at least two fin antennas. The housing has at least two raised portions formed on a top thereof and a concave portion formed between every two adjacent raised portions. The housing has at least two receiving spaces defined in an inner periphery thereof, wherein each receiving space aligns with a corresponding one of at least two the raised portions and each fin antenna is received in a corresponding one of the at least two receiving spaces. The fin antennas are provided for respectively transceiving wireless signals.

### CROSS-REFERENCE TO RELATED U.S. APPLICATIONS

Not applicable.

### STATEMENT REGARDING FEDERALLY SPONSORED RESEARCH OR DEVELOPMENT

Not applicable.

### NAMES OF PARTIES TO A JOINT RESEARCH AGREEMENT

Not applicable.

### REFERENCE TO AN APPENDIX SUBMITTED ON COMPACT DISC

Not applicable.

### BACKGROUND OF THE INVENTION

1. Field of the Invention

The present invention relates to an antenna, and more particularly to a multi-fin antenna assembly.

2. Description of Related Art Including Information Disclosed Under 37 CFR 1.97 and 37 CFR 1.98.

Recently, the communication requirements in a vehicle have become more and more complex, including satellite navigation systems (ex. GPS), mobile phones, Wi-Fi, radio, digital TV, and so on. A conventional single-functional antenna cannot meet the multi-function needs so that an antenna assembly for integrating the multi-functional requirement is very important.

The conventional antenna assembly for use on a vehicle usually has one or two functions and has a single fin outward appearance. However, the conventional antenna assembly cannot be used for multi-functional requirements. For providing multi-function, the conventional antenna assembly needs to be altered to have multiple antenna units disposed in a conventional single-fin housing. However, the antenna units need to be separated from one another for reducing interference. As a result, the receiving space in the single fin housing needs to be advantageously altered.

The present invention has arisen to mitigate and/or obviate the disadvantages of the conventional antenna assembly.

### BRIEF SUMMARY OF THE INVENTION

The main objective of the present invention is to provide an improved multi-fin antenna assembly for receiving different wireless signals and providing different functions.

To achieve the objective, the multi-fin antenna assembly in accordance with the present invention comprises a seat, at least two fin antennas disposed on the seat and corresponding to each other, and a housing mounted onto the seat for covering the at least two fin antennas. The housing has at least two raised portions formed on a top thereof and a concave portion formed between every two adjacent raised portions. The housing has at least two receiving spaces defined in an inner periphery thereof, wherein each receiving space aligns with a corresponding one of at least two the raised portions and each fin antenna is received in a corresponding one of the at least two receiving spaces. The fin antennas are provided for respectively transceiving wireless signals.

Further benefits and advantages of the present invention will become apparent after a careful reading of the detailed description with appropriate reference to the accompanying drawings.

BRIEF DESCRIPTION OF THE SEVERAL VIEWS OF THE DRAWINGS

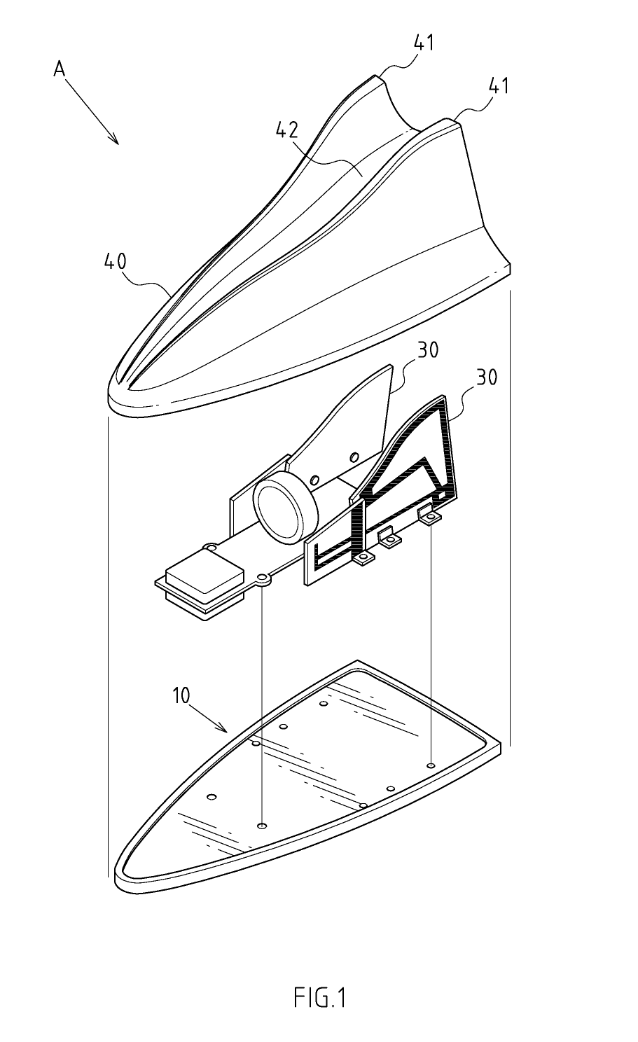

FIG. 1 is an exploded perspective view of a multi-fin antenna assembly in accordance with the present invention;

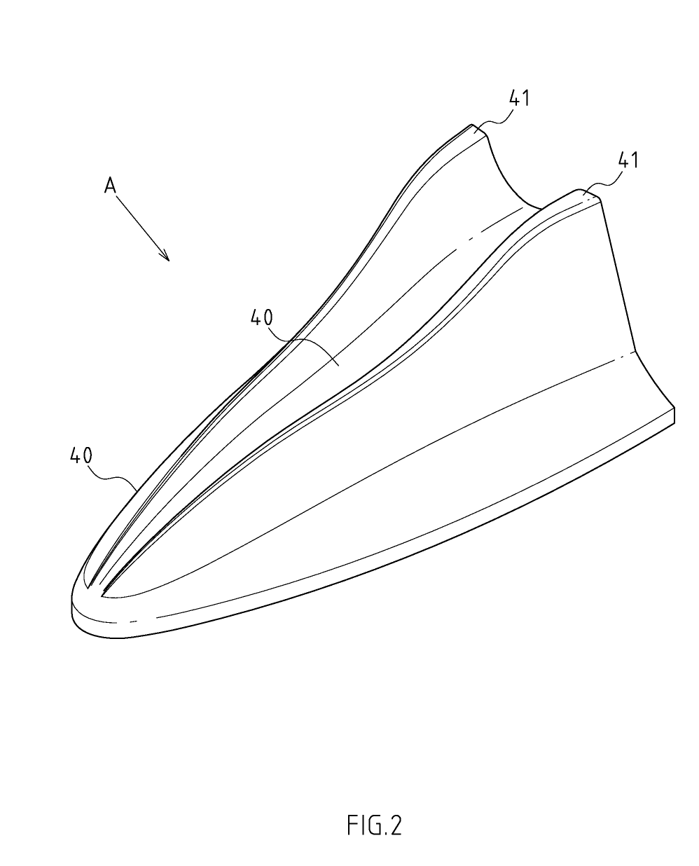

FIG. 2 is a perspective view of a multi-fin antenna assembly in accordance with the present invention;

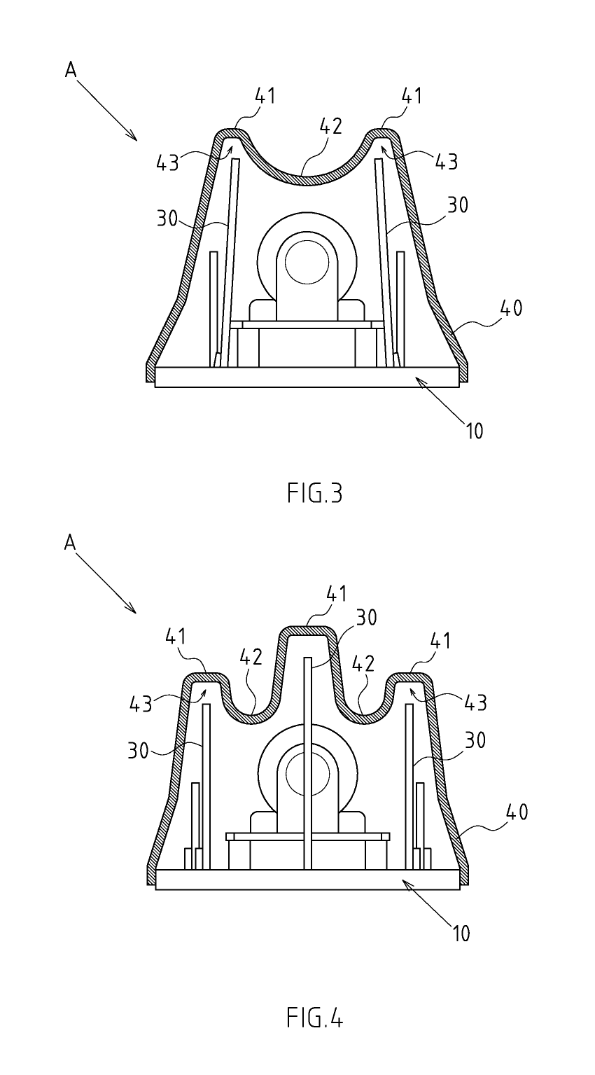

FIG. 3 is a cross-sectional view of the multi-fin antenna assembly in FIG. 2;

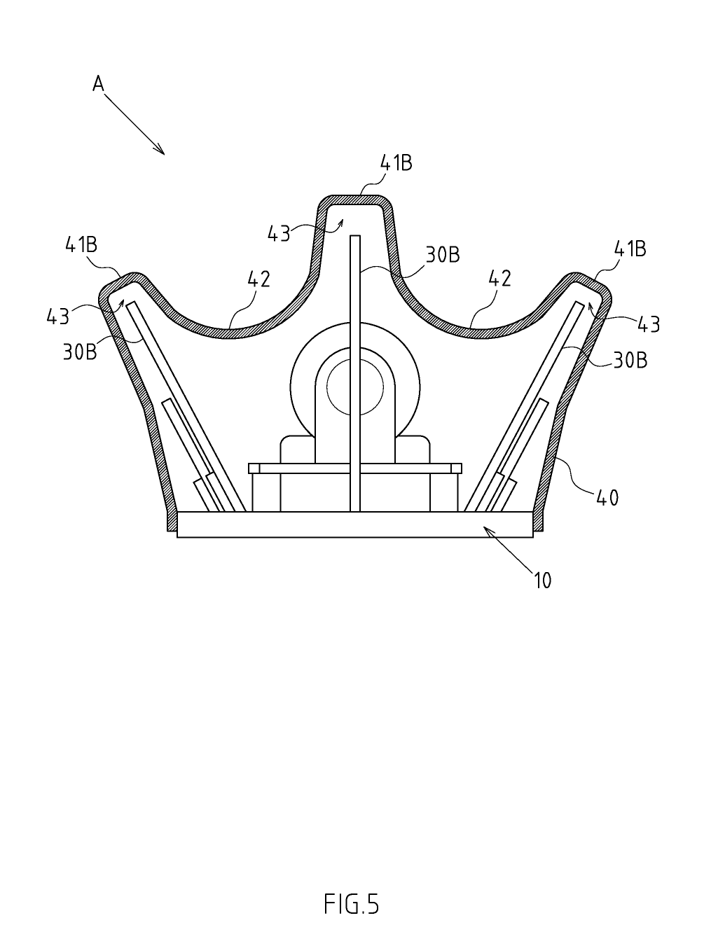

FIG. 4 is a cross-sectional view of a second embodiment of the multi-fin antenna assembly in accordance with the present invention;

FIG. 5 is a cross-sectional view of a third embodiment of the multi-fin antenna assembly in accordance with the present invention; and

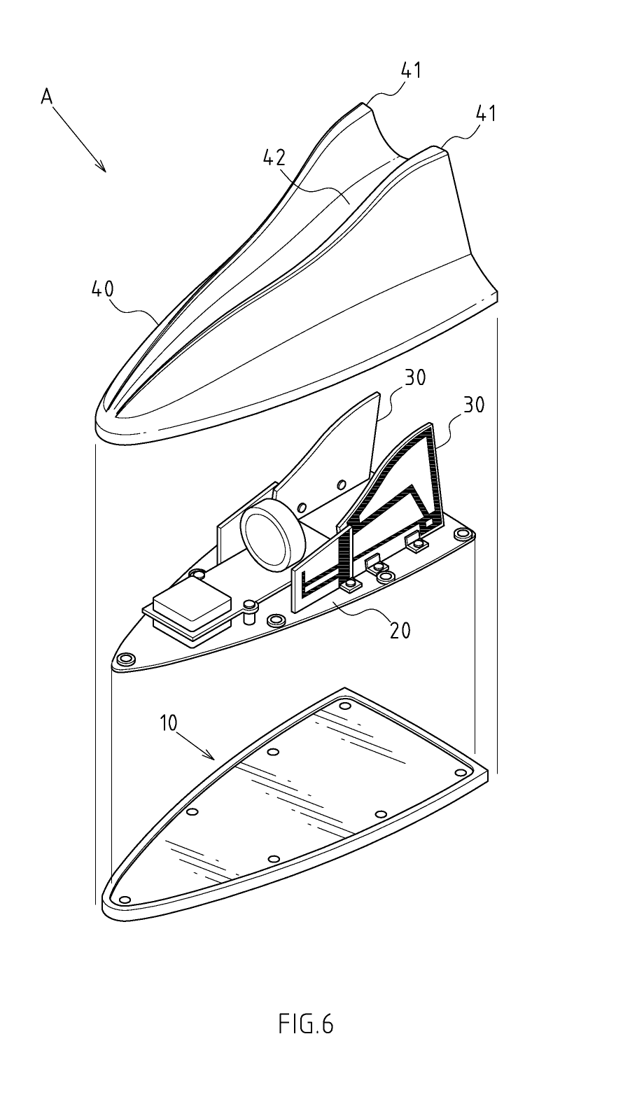

FIG. 6 is an exploded perspective view of a fourth embodiment of the multi-fin antenna assembly in accordance with the present invention.

### DETAILED DESCRIPTION OF THE INVENTION

Referring to the drawings and initially to FIGS. 1-3, a multi-fin antenna assembly A in accordance with the present invention comprises seat 10, at least two fin antennas 30 disposed on the seat 10 and corresponding to each other, and a housing 40 mounted onto the seat 10 for covering the at least two fin antennas 30. The housing 40 has at least two raised portions 41 formed on a top thereof and a concave portion 42 formed between every two adjacent raised portions 41. The housing 40 has at least two receiving spaces 43 defined in an inner periphery thereof, wherein each receiving space 43 aligns with a corresponding one of the at least two raised portions 41 and each fin antenna 30 is received in a corresponding one of the at least two receiving spaces 43. The fin antennas 30 are provided for respectively transceiving wireless signals.

With reference to FIG. 3, the at least two fin antennas 30 are vertically mounted onto the seat 10 and parallel to each other such that the at least two raised portions 41 respectively vertically correspond to the seat 10. With reference to FIG. 4 that shows a second embodiment of the multi-fin antenna assembly A in accordance with the present invention, in this embodiment, the multi-fin antenna assembly A includes three fin antennas 30 respectively vertically mounted onto the seat 10 and parallel to one another such that the housing 40 has three raised portions 41 being vertical relative to the seat 10 and three corresponding concave portions 43 for receiving the three fin antennas 30.

With reference to FIG. 5 that shows a third embodiment of the multi-fin antenna assembly A in accordance with the present invention, in this embodiment, the multi-fin antenna assembly A includes three fin antennas 30B respectively radially mounted onto the seat 10 such that the housing 40 has three raised portions 41B being radial relative to the seat 10 and three corresponding concave portions 43 for receiving the three fin antennas 30.

With reference to FIG. 6 that shows a fourth embodiment of the multi-fin antenna assembly A in accordance with the present invention, in this embodiment, the seat 10 further includes a circuit board 20 secured thereon and the at least two fin antennas 30 are secured on the circuit board 20. As described above, a characteristic of the multi-fin antenna assembly in accordance with the present invention is to form multiple raised portions 41 on a top of the housing 40 and concave portions 42 between every two adjacent raised portions 41, wherein each receiving space 43 in the inner periphery of the housing 40 aligns with a corresponding one of the raised portions 41 and each fin antenna 30 extends into a corresponding one of the multiple receiving spaces 43. As a result, the fin antennas 30 are provided to respectively receive different wireless signals and provide different functions. In detailed description about the antenna design, for various wireless communication requirements, there are multiple antennas unit disposed in an antenna assembly. For achieving excellent electrical performance characteristics, the fin antennas 30 of the present invention are respectively and separately mounted onto the seat 10 or circuit board 20. For receiving multiple fin antennas 30, providing low drag coefficient, being streamlined and used on a roof of a vehicle, the housing 40 in accordance with the present invention includes multiple raised portions 41, and multiple receiving spaces 43 defined in the inner periphery of the housing 40 and each receiving space 43 aligning with a corresponding one of the raised portions 41 for receiving a corresponding fin antenna 30. In addition, a concave portion 42 is formed between every two adjacent raised portions 41 for reducing the windward area of the housing 40 of the present invention.

As described above, the multi-fin antenna assembly A in accordance with the present invention comprises the seat 10, at least two fin antennas 30 mounted onto the seat 10 and a housing 40 mounted onto the seat 10 for covering the at least two fin antennas 30, wherein the housing 40 includes multiple raised portions 41, and multiple receiving spaces 43 defined in the inner periphery of the housing 40 and each receiving space 43 aligning with a corresponding one of the raised portions 41 for receiving a corresponding fin antenna 30, and a concave portion 42 is formed between every two adjacent raised portions 41. As a result, the multi-fin antenna assembly can be used on a vehicle for receiving different wireless signals and providing different functions and reducing windward area of the housing 40 due to the shape of the housing 40.

Although the invention has been explained in relation to its preferred embodiment, it is to be understood that many other possible modifications and variations can be made without departing from the spirit and scope of the invention as hereinafter claimed.

We claim:

1. A multi-fin antenna assembly comprising:
a seat;
at least two fin antennas disposed on the seat and corresponding to each other for respectively transceiving wireless signals; and
a housing mounted onto the seat for covering the at least two fin antennas, the housing having at least two raised portions formed on a top thereof and a concave portion formed between every two adjacent raised portions, the housing having at least two receiving spaces defined in an inner periphery thereof, wherein each receiving space aligns with a corresponding one of the at least two raised portions and each fin antenna is received in a corresponding one of the at least two receiving space.

2. The multi-fin antenna assembly as claimed in claim 1, wherein the at least two fin antennas are vertically mounted onto the seat and parallel to each other such that the at least two raised portions respectively vertically correspond to the seat.

3. The multi-fin antenna assembly as claimed in claim 1, wherein the at least two fin antennas are respectively radially mounted onto the seat such that the at least two raised portions being radial relative to the seat and the at least two corresponding receiving spaces for receiving the at least two fin antennas.

4. The multi-fin antenna assembly as claimed in claim 2, further including a circuit board secured thereon, wherein the at least two fin antennas is secured on the circuit board.

5. The multi-fin antenna assembly as claimed in claim 3, further including a circuit board secured thereon, wherein the at least two fin antennas are secured on the circuit board.
